(19) United States
(12) Patent Application Publication
(10) Pub. No.: US 2026/0134465 A1
(43) Pub. Date: May 14, 2026

(54) AUTONOMOUS CREATION OF AGREEMENTS

(71) Applicant: ChannelFourAI, Inc., Austin, TX (US)

(72) Inventor: Ryan Richard, Austin, TX (US)

(21) Appl. No.: 18/943,780

(22) Filed: Nov. 11, 2024

(51) Int. Cl. G06Q 30/0601; G06F 40/279; G06F 40/40

(52) U.S. Cl. CPC G06Q 30/0617; G06F 40/279; G06F 40/40

(57) ABSTRACT

A system for autonomous creation of agreements. The system includes an electronic processor configured to, using a buyer manager artificial intelligence (AI) agent, select a buyer AI sub-agent of a plurality of buyer AI sub-agents, using the selected buyer AI sub-agent, generate and send an initial electronic communication to a seller manager AI agent, and, using the seller manager AI agent, select a seller AI sub-agent of a plurality of seller AI sub-agents based on an electronic conversation history. The electronic processor is also configured to, using the selected seller AI sub-agent, generate and send a response to the buyer manager AI agent based on listing data associated with a seller and the electronic conversation history and determine whether an electronic conversation is terminated. The electronic processor is also configured to, in response determining the agreement is reached, convert unstructured electronic conversation into a structured agreement.

### FIELD

Implementations described herein relate to the automation of commercial agreements.

### SUMMARY

The process of commerce may be broken down into the following categories: 1) research and discovery, 2) requirements and verification, 3) negotiation, 4) payment, and 5) exchange. Historically, categories 2) requirements and verification and 3) negotiation happen in 2 modes:
1. Buyer-led and transactional-buyers verify a particular good or service meets their needs and purchase it.
2. Human to human conversation-buyers discuss their requirements with a representative of the seller, determine if it meets their needs, and choose to make a purchase.

Implementations described herein allow users (buyers and sellers) to express their needs (for example, goods or services a buyer wishes to purchase) and products (for example, goods or services a seller wishes to sell) using natural language input. Today, electronic commerce systems limit users to searching, verifying, transacting, etc. using only what is supported by the electronic commerce system's data structure. Users may use, for example, pre-programmed filters to find the appropriate item or service. For example, if price filters provided for a user to select from include 1) goods priced under 100 dollars, 2) goods priced between 100 and 500 dollars, and 3) goods priced over 500 dollars, a user may not have a way to easily find goods priced between 25 and 50 dollars without sifting through listings of goods priced under 100 dollars. If a user wishes to find goods associated with a quality, quantity, or any other facet for which the electronic commerce system does not have a filter, the user may be forced to look elsewhere or contact a seller directly and converse human-to-human.

For example, current electronic commerce systems do not allow buyers to find goods using listing data such as the following: “I want to buy a high end specialized road bike. If it was made prior to 2022 I will pay up to $3000 or $3500 if it was made after. If the components are a lower grade than X, reduce my acceptable price by 10%.”

In current electronic commerce systems a user may be able to specify the brand of product they require, a maximum price threshold, a minimum price threshold, or the like. However, a user likely cannot select a year of manufacture with respect to the grade of components of the product. Even in a current electronic commerce system where a user could select a year of manufacture, the user may need to select all years of manufacture of products that they would be willing to purchase and then cross-reference the year of manufacture of the product with the price of the product themselves. Electronic commerce systems today do not have the capability to utilize the final requirement included in the above example listing data, “[i]f the components are a lower grade than X, reduce my acceptable price by 10%.” This final requirement requires an understanding what is considered “lower grade” and the ability to dynamically adjust the price the buyer is willing to pay based on the grade of components. Today, a user must check this requirement is met themselves, without aid from the electronic-commerce system.

The implementations described herein allow users (buyers and sellers) to more accurately represent their needs and products by using artificial intelligence (AI) agents and large language models.

In the implementations described herein, independent AI agents may act as proxies for independent entities (for example, a buyer and a seller) in order to facilitate an agreement (for example, the buying and selling of goods and services). This allows electronic commerce to take place in a way that is not restricted by constraints of an application or structured data. The implementations described herein allow buyers to be discoverable to sellers and for a buyer's requirements to be verified through natural language and not be bound to structured data. Implementations described herein also provide a common system for goods and services to be verified and procured.

For example, one implementation provides a system for autonomous creation of agreements. The system includes an electronic processor. The electronic processor is configured to, using a buyer manager artificial intelligence (AI) agent, select a buyer AI sub-agent of a plurality of buyer AI sub-agents, using the selected buyer AI sub-agent, generate and send an initial electronic communication to a seller manager AI agent, and, using the seller manager AI agent, select a seller AI sub-agent of a plurality of seller AI sub-agents based on an electronic conversation history. The electronic conversation history includes 1) the initial electronic communication or 2) the initial electronic communication and one or more responses generated by one of the plurality of buyer AI sub-agents or one of the plurality of seller AI sub-agents. The electronic processor is also configured to, using the selected seller AI sub-agent and a seller large language model, generate and send a response to the buyer manager AI agent based on listing data associated with a seller and the electronic conversation history. The electronic processor is further configured to, using the buyer manager AI agent, select a buyer AI sub-agent of the plurality of buyer AI sub-agents based on the electronic conversation history and listing data associated with a buyer, using the selected buyer AI sub-agent and a buyer computer implemented large language model, generate and send a response to the seller manager AI agent based on the listing data associated with the buyer and the electronic conversation history, and determine whether an electronic conversation is terminated. The electronic processor is also configured to, in response to determining the electronic conversation is terminated, determine whether an agreement is reached and, in response determining the agreement is reached, convert unstructured electronic conversation into a structured agreement.

Another implementation provides a system for autonomous creation of agreements. The system includes an electronic processor. The electronic processor is configured to, using a seller manager artificial intelligence (AI) agent, select a seller AI sub-agent of a plurality of seller AI sub-agents, using the selected seller AI sub-agent, generate and send an initial electronic communication to a buyer manager AI agent, and, using the buyer manager AI agent, select a buyer AI sub-agent of a plurality of buyer AI sub-agents based on an electronic conversation history. The electronic conversation history includes 1) the initial electronic communication or 2) the initial electronic communication and one or more responses generated by one of the plurality of seller AI sub-agents or one of the plurality of buyer AI sub-agents. The electronic processor is also configured to, using the selected buyer AI sub-agent and a buyer large language model, generate and send a response to the seller manager AI agent based on listing data associated with a buyer and the electronic conversation history. The electronic processor is further configured to, using the seller manager AI agent, select a seller AI sub-agent of the plurality of seller AI sub-agents based on the electronic conversation history and listing data associated with a seller, using the selected seller AI sub-agent and a seller large language model, generate and send a response to the buyer manager AI agent based on the listing data associated with the seller and the electronic conversation history, and determine whether an electronic conversation is terminated. The electronic processor is also configured to, in response to determining the electronic conversation is terminated, determine whether an agreement is reached and, in response determining the agreement is reached, convert unstructured electronic conversation into a structured agreement.

Yet another implementation provides a method for autonomous creation of agreements. The method includes, using a buyer manager AI agent, selecting a buyer artificial intelligence (AI) sub-agent of a plurality of buyer AI sub-agents, using the selected buyer AI sub-agent, generating and send an initial electronic communication to a seller manager AI agent, and, using the seller manager AI agent, selecting a seller AI sub-agent of a plurality of seller AI sub-agents based on an electronic conversation history. The electronic conversation history includes 1) the initial electronic communication or 2) the initial electronic communication and one or more responses generated by one of the plurality of buyer AI sub-agents or one of the plurality of seller AI sub-agents. The method also includes, using the selected seller AI sub-agent and a seller large language model, generating and send a response to the buyer manager AI agent based on listing data associated with a seller and the electronic conversation history. The method further includes, using the buyer manager AI agent, selecting a buyer AI sub-agent of the plurality of buyer AI sub-agents based on the electronic conversation history and listing data associated with a buyer, using the selected buyer AI sub-agent and a buyer large language model, generating and send a response to the seller manager AI agent based on the listing data associated with the buyer and the electronic conversation history, and determining whether an electronic conversation is terminated. The method also includes, in response to determining if the electronic conversation is terminated, determining whether an agreement is reached and, in response determining the agreement is reached, converting unstructured electronic conversation into a structured agreement.

### BRIEF DESCRIPTION OF THE DRAWINGS

FIG. 1 illustrates an example system for the autonomous creation of agreements, in accordance with some implementations.

FIG. 2A-B are a flowchart of an example method for autonomous creation of agreements, in accordance with some implementations.

FIG. 3 is a flowchart of an example method for autonomous creation of agreements, in accordance with some implementations.

FIG. 4 is flowchart of an example method for receiving and processing listing data, in accordance with some implementations.

FIG. 5 provides a flowchart of an example method for matching listing data associated with the buyer to the listing data associated with the seller, in accordance with some implementations.

FIG. 6 provides an example flowchart of communications between AI agents, in accordance with some implementations.

FIG. 7 is a flowchart of a method for determining whether a good or service sold by a seller meets the requirements for the good or service established in listing data associated with a buyer, in accordance with some implementations.

FIG. 8 is a flowchart of a method for responding to a communication from a buyer AI agent inquiring about a requirement for the good or service established in the listing data associated with the buyer, in accordance with some implementations.

FIG. 9 is an example diagram illustrating communications exchanged between software components to perform the method of FIG. 2A-B, in accordance with some implementations.

FIG. 10 is an example diagram of a database schema for an agreement, in accordance with some implementations.

FIG. 11 is an example diagram of an electronic conversation between buyer and seller AI agents regarding a requirement in listing data associated with the buyer, in accordance with some implementations.

FIG. 12 is an example diagram of an electronic conversation between buyer and seller AI agents regarding price, in accordance with some implementations.

### DETAILED DESCRIPTION

Before any implementations, examples, aspects, and features are explained in detail, it is to be understood that they are not limited in their application to the details of construction and the arrangement of components set forth in the following description or illustrated in the following drawings. Other implementations, examples, aspects, and features are possible, and they are capable of being practiced or of being carried out in various ways.

For case of description, some or all of the example systems presented herein are illustrated with a single exemplar of each of its component parts. Some examples may not describe or illustrate all components of the systems. Other examples may include more or fewer of each of the illustrated components, may combine some components, or may include additional or alternative components.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

It should also be understood that although certain drawings illustrate hardware and software located within particular devices, these depictions are for illustrative purposes only. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links.

Thus, in the claims, if an apparatus or system is claimed, for example, as including an electronic processor or other element configured in a certain manner, for example, to make multiple determinations, the claim or claim element should be interpreted as meaning one or more electronic processors (or other element) where any one of the one or more electronic processors (or other element) is configured as claimed, for example, to make some or all of the multiple determinations. To reiterate, those electronic processors and processing may be distributed.

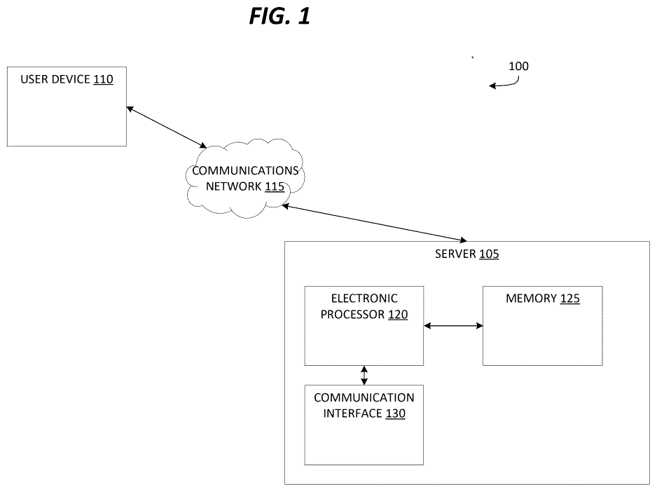

FIG. 1 illustrates an example system 100 for the autonomous creation of agreements. The system 100 illustrated in FIG. 1 includes a server 105 and a user device 110. The server 105 and the user device 110 may communicate via the communications network 115. The communications network 115 is a communications network including wireless connections, wired connections, or combinations of both. The communications network 115 may be implemented using a wide area network, for example, the Internet, a Long-Term Evolution (LTE) network, a 4G network, 5G network, or one of their successors, and one or more local area networks, for example, a Bluetooth™ network or Wi-Fi network, and combinations or derivatives thereof. While the system 100 illustrated in FIG. 1 includes a single user device 110 and a single server 105, it should be understood that the system 100 may include multiple servers and multiple user devices and that the functionality described herein as being performed by the server 105 may in fact be performed by multiple servers included in the system 100.

The server 105 includes an electronic processor 120 (for example, a microprocessor, application specific integrated circuit, etc.), a memory 125, and a communication interface 130. The memory 125 may be made up of one or more non-transitory computer-readable media. The memory 125 can include combinations of different types of memory, such as read-only memory (“ROM”), random access memory (“RAM”), electrically erasable programmable read-only memory (“EEPROM”), flash memory, or other suitable memory devices. The electronic processor 120 is coupled to the memory 125 and the communication interface 130. The electronic processor 120 sends and receives information (for example, from the memory 125 and/or the communication interface 130) and processes the information by executing one or more software instructions or modules, capable of being stored in the memory 125, or another non-transitory computer readable medium. The software can include firmware, one or more applications, program data, filters, rules, one or more program modules, and other executable instructions. The electronic processor 120 is configured to retrieve from the memory 125 and execute, among other things, software for performing methods as described herein.

The user device 110 may be a personal computer, a laptop, a tablet, a smart phone, a smart wearable, or the like. The user device 110 may include an electronic processor, memory, and communication interface that are similar to the electronic processor 120, memory 125, and communication interface 130 included in the server 105. In some implementations, the user device 110 also includes an input device (for example, a keyboard, a microphone, a camera, a touch screen, or the like) and/or an output device (for example, a screen, a speaker, or the like) (not illustrated).

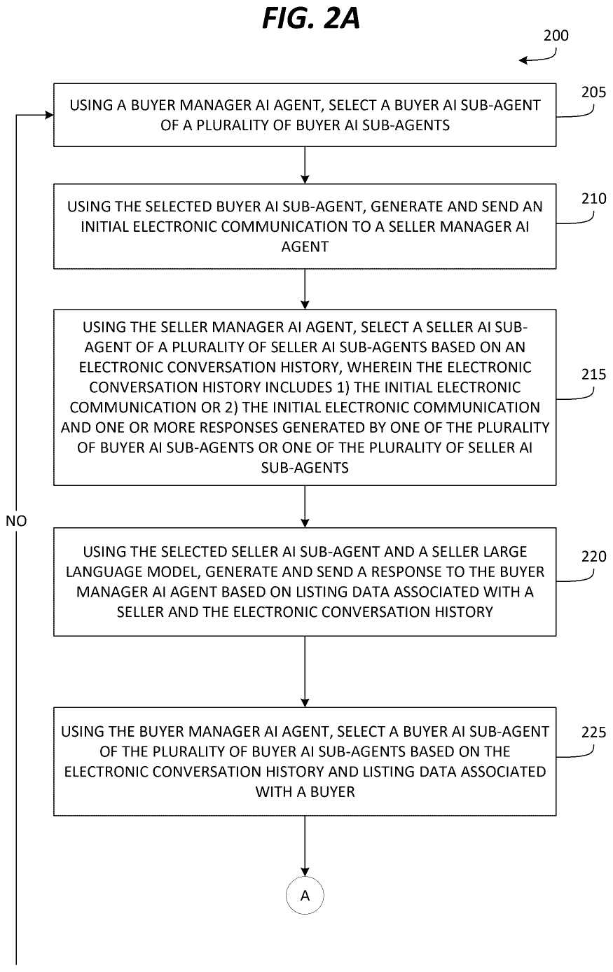

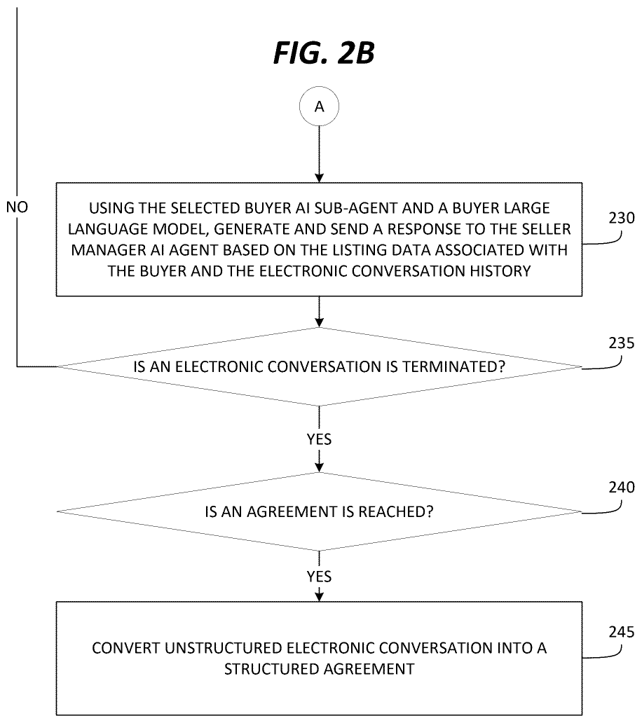

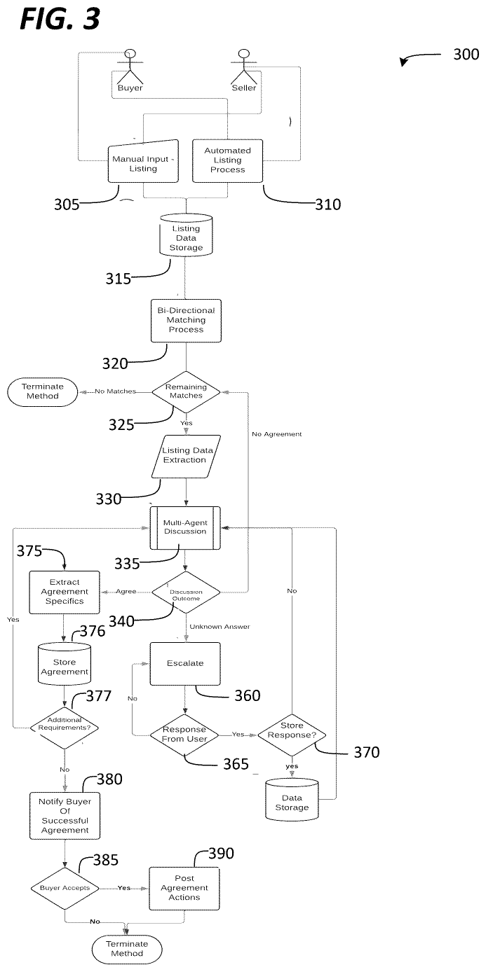

FIG. 2A-B is a flowchart of an example method 200 for autonomous creation of agreements. FIG. 3 provides another flowchart of an example method 300 for autonomous creation of agreements.

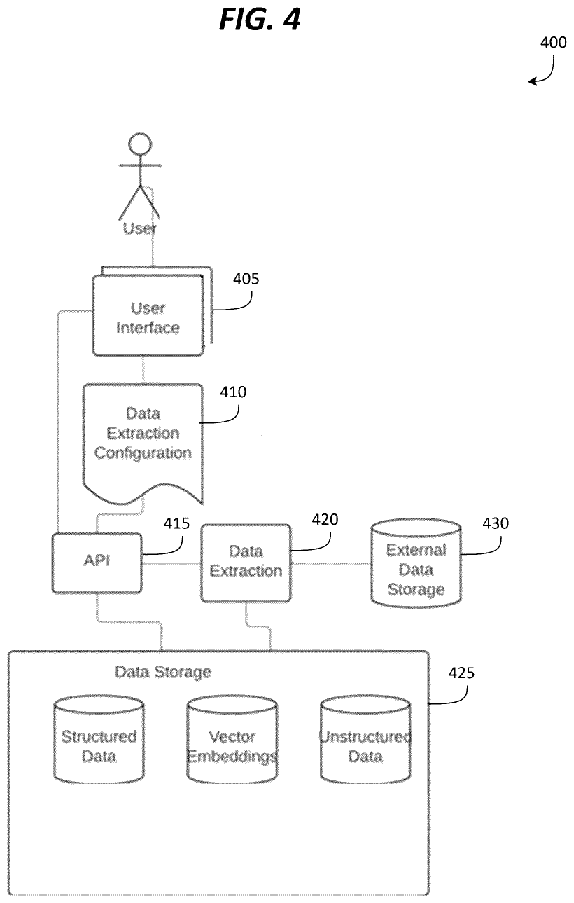

In some implementations, prior to performing the method 200, the electronic processor 120 receives listing data associated with a buyer from a user device (for example, the user device 110) (block 305 of FIG. 3). The electronic processor 120 may also receive listing data associated with a seller from a user device (for example, the user device 110) (block 305 of FIG. 3). FIG. 4 provides a flowchart of a method 400 for receiving and processing listing data. As represented by block 405 in FIG. 4, a user device (for example, the user device 110) may receive listing data from a user (for example, a buyer or a seller) via an input device when the user enters listing using a user interface (for example, when a user enters information using a touch screen displaying a graphical user interface (GUI)). The electronic processor of the user device 110 may receive the raw listing data when the user enters the raw listing data in a structured format (for example enters the raw listing data into a plurality of fields (such as title, description, price, and the like) displayed via the GUI. In some implementations, the listing data may include one or more natural language elements. In some implementations, the listing data may include unstructured data, such as a natural language description. The electronic processor of the user device 110 may also receive, as raw listing data, unstructured data such as images, video, text, and audio. In some implementations, the electronic processor of the user device may receive a web address or uniform resource locator (URL) from a seller. The seller AI agents (described in more detail below) may utilize the provided web address or URL to retrieve additional data regarding the goods or service being offered for sale.

In some implementations, the electronic processor of the user device 110 may extract relevant listing data from the raw listing data (block 410) and send the relevant listing data to the server 105 via an application programming interface (API) (block 415). In other implementations, the electronic processor of the user device 110 sends the raw listing data to the server 105. The electronic processor 120 of the server 105 may extract relevant listing data from the raw listing data (block 420) by, for example, converting video, audio, and image data to unstructured text data and extracting structured data from unstructured text data. The electronic processor 120 may store the relevant listing data in the memory 125 (block 425). The relevant listing data may be stored as structured data, unstructured data, and vectorized data. The structured data may include data associated with one or more fields, for example, required fields included in listing data associated with buyers or sellers. The unstructured data may include natural language text, images, videos, audio recordings, or the like. Vectorized data may include vectors or arrays of data representing the listing data associated with buyers or sellers. In some implementations, the electronic processor 120 stores the relevant listing data in a location external to the server 105 (for example, a database) (block 430). The storage of relevant buyer or seller listing data in the memory 125 or a storage device external to the server 105 is represented by block 315 of FIG. 3.

Below is an example of elements that may be extracted from the raw listing data received by the electronic processor of the user device 110 from a buyer:
1. ID of the buyer (may be a user ID or organization ID)
2. ID of the listing
3. Description of item or service (may be written in natural language)
4. List of buyer requirements in the form of facet and expected response (for example, brand is ABC) that are not already included in the description.
5. Location of the buyer (for example, an address or zip code)
6. Buyer preference for procurement (for example, local pickup, delivery, or the like)
7. Number of items to procure (if applicable)
8. Acceptable price range (may be written in natural language)
9. Images, video, and/or audio (for example, an image of an item the buyer wants to purchase)
10. Title
11. URL of a webpage describing the item or service

Below is an example of listing data associated with a buyer extracted from raw listing data:
User ID: 123
Listing ID: 123456
Description: used mountain bike with full suspension, carbon frame
Requirements:
   Quality is used
   Frame: Carbon Fiber
   Has Full Suspension
   Accessories: water bottle holder
Location: 78739
Procurement Type: Local Pickup
Number of Items: 1
Acceptable Price Range: Up to $5000

Below is an example of elements that may be extracted from the raw listing data received by the electronic processor of the user device 110 from a seller:
1. ID of the seller (may be a user ID or organization ID)
2. ID of the listing
3. Listing title (may be written in natural language)
4. Listing description (may be written in natural language)
5. Location of the item or service (for example, a zip code)
6. Availability (for example, when the item or service can be procured)
7. Buyer procurement options (for example, local pickup, delivery, and the like)
8. Inventory (for example, a number of items for sale, availability to perform a service, or the like)
9. Listing price
10. Acceptable price range (may be written in natural language)
11. Images, video, audio
12. URL of a webpage describing the item or service

Below is an example of listing data associated with a seller extracted from raw listing data:
User ID: 456
Listing ID: 456789
Title: Mountain Bike
Description: Mountain Bike. Blue and red color scheme. This bike is in excellent condition and has been ridden very little. It is ready to hit the trails! It has a carbon fiber frame and ABC drivetrain. The bike is equipped with a QRS fork and a TUV rear shock. It also has a set of WXY wheels. The bike is a large. A new one retails for up to $11,000.
Location: 78739
Availability: Immediate
Buyer Procurement Options: Local Pickup
Inventory: 1
Listing Price: $2,000
Acceptable Price Range: As low as $1,750

Returning to FIG. 3, as represented by block 310, the electronic processor 120 may receive an indication of a database, website, document, a combination of the foregoing, or the like. The electronic processor 120 may retrieve listing data from the database, website, document, a combination of the foregoing, or the like using, for example, structured query language (SQL), HTML or text from Internet sites, document text extraction, a combination of the foregoing, or the like. The functionality described in relation to block 310 allows listing data to be created and managed in bulk. In some implementations, the electronic processor 120 may remove or delete a listing when a request to remove may remove a listing is received from the user device 110.

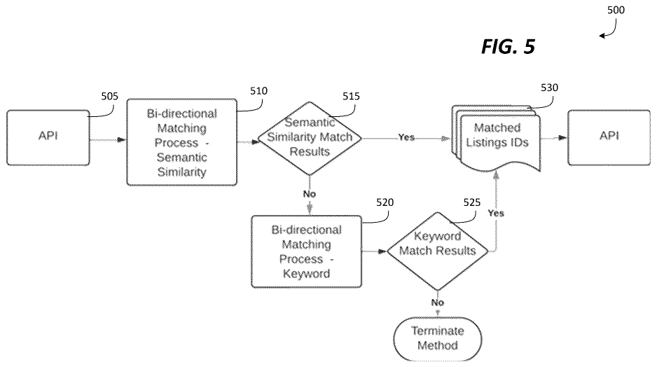

At block 320, the electronic processor 120 matches the listing data associated with the buyer to the listing data associated with the seller. FIG. 5 provides a flowchart of an example method 500 for matching listing data associated with the buyer to the listing data associated with the seller. At block 505, the electronic processor 120 may utilize an API to perform the matching. At block 510, the electronic processor 120 performs bi-directional matching using semantic similarity with a similarity threshold to match listing data associated with the buyer to the listing data associated with the seller. In some implementations, semantic similarity between buyer and seller listing data is determined using a distance metric (for example, cosine) between vector embeddings of the listings. In some implementations, at block 515, the electronic processor 120 determines whether one or more matches between buyer or seller listing data have been produced using semantic similarity. In some implementations, when no matches are produced using semantic similarity, the electronic processor 120, at block 520, utilizes keyword matching (for example, BM25 keyword-based matching) to determine matches between seller and buyer listing data. In other implementations, the electronic processor 120 may perform the functionality described in relation to block 520 even when, at block 515, the electronic processor 120 determines that one or matches are produced. At block 525, the electronic processor 120 determines whether one or more matches between seller and buyer listing data exist. When no matches are determined using keyword matching, the electronic processor 120 may cease performing the method 500 and, in turn, the method 300. When one or matches are determined between listing data associated with the buyer and listing data associated with the seller, at block 530, the electronic processor 120 may utilize an API to return the one or more matches to the software being executed to perform the method 300. In some implementations, the electronic processor 120 performs additional, fewer, or different matching techniques than those discussed in FIG. 5. For example, in some implementations, the electronic processor 120 may utilize one or more structured data filters to determine one or more matches.

Returning to FIG. 3, at block 325, the electronic processor 120 determines whether a match between listing data associated with the buyer and listing data associated with the seller exists that has not been discussed or examined by AI agents. In some implementations, at block 330, the electronic processor 120, extracts or retrieves from memory (for example, the memory 125 or a remote database (not illustrated)) listing data associated with the buyer and listing data associated with the seller of a next matched pair (for example, matched pairs of buyer and seller listing data may be stored in a queue or list data structure and the electronic processor 120 may retrieve the next matched pair from the list or queue).

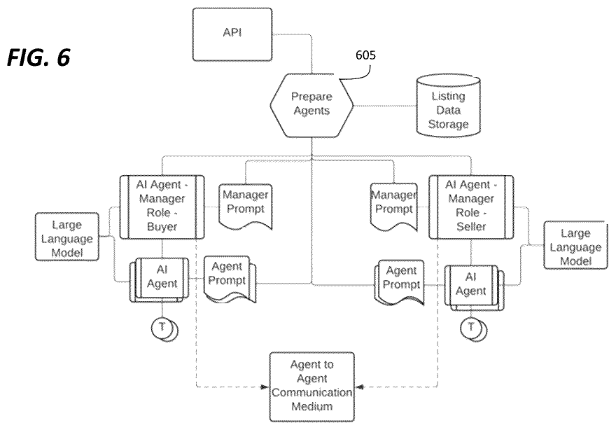

At block 335, the electronic processor 120, begins an electronic conversation between AI agents to autonomously create an agreement. In other words, the electronic processor 120 begins to perform the method 200. FIG. 6 provides an example flowchart of communications between AI agents. AI Agents are a new type of computational process created through traditional programming techniques such as Object Oriented Programming and newer Generative AI techniques including Prompt Engineering and ReACT prompting. AI agents are not programmed to follow an explicit set of logic and instead are given rich natural language instructions to inform them of their goal. The path an AI agent uses to achieve its goal is non-deterministic. Instructions are provided to the AI agents in a natural language prompt inform the AI agent of boundaries or parameters it must stay within when attempting to achieve its goal to what actions to take in certain circumstances.

Tools are programmatic functions that agents may call in order to take an action when certain criteria are met. When to use or call a tool may be determined by an LLM processing instructions in a prompt (for example, the prompts described below). The LLM may be trained and configured to generate output that includes the name of the tool to call and the parameters required by the tool based on the information in a prompt. The software process coordinating the AI agent discussion may call the tool with the parameters provided by the LLM output.

Tools may be created prior to the AI agent discussion beginning. A description of when to use a tool, a definition of a tool, and one or more parameters or inputs required by the tool may be included in the prompts used to create an AI agent or perform a task using an AI agent. Tools allow the conversion of unstructured text into a structured format as defined by the tool. Tools may provide additional capabilities for the AI agents, such as the ability to look up additional data in order to respond to a question or query from another AI agent.

It should be noted that other AI agent configurations may be utilized to implement the invention. For example, the AI agents may be structured so that there are more than two levels of AI agents (levels additional to manager agents (level 1) and sub-agents (level 2)). In another example, the AI agents may not have a hierarchical structure so long as the appropriate instructions, information, and tools are provided to them.

In some implementations, prior to performing the functionality described in relation to block 205 of FIG. 2A, the electronic processor 120 creates a buyer manager AI agent based on a first prompt and a seller manager AI agent based on a second prompt (represented by block 605 of FIG. 6). The first prompt includes a list and description of available buyer AI sub-agents, guidance and examples of actions to take, response instructions and examples, and an electronic conversation history, a combination of the foregoing, or the like. The second prompt includes a list and description of available seller AI sub-agents, guidance and examples of actions to take, response instructions and examples, and an electronic conversation history, a combination of the foregoing, or the like. The buyer manager AI agent and seller manager AI agent may parse an incoming question, and choose which sub-agent is best equipped to solve the question. It should be understood that any functionality described herein as being performed by an AI agent or large language model is, in fact, performed by an electronic processor (for example, the electronic processor 120) executing an AI agent or large language model.

In some implementations, the electronic processor 120 also creates a plurality of buyer AI sub-agents including a negotiator AI agent and a listing AI agent and a plurality of seller AI sub-agents including negotiator AI agent and a listing AI agent. The buyer AI sub-agents and seller AI sub-agents may include additional AI sub-agents. For example, seller AI sub-agents may include a seller AI sub-agent that, when executed, looks up or edits current information (for example, the number of units remaining, the estimate cost to ship, or the like) included in a seller system of record. Each sub-agent is given its own prompt, data, and tools to complete its job or task when called.

The following is an example of a prompt that may be utilized to create the buyer manager AI agent and the seller manager AI agent:

```
  Manager AI Agent Prompt:
  You are a manager of multiple agents. For an incoming message, you need to choose the right agent to respond
and review their work.
  available agents:
  <LIST AND DESCRIPTION OF AVAILABLE AGENTS>
  guidance:
  <GUIDANCE AND EXAMPLES OF ACTIONS TO TAKE>
  response instructions:
  <RESPONSE INSTRUCTIONS AND EXAMPLES>
  Here is the entire chat history to help you choose which agent the next comment or question should go to:
  <CHAT HISTORY>
```

The following is an example of a prompt that may be utilized to create the seller listing AI agent:

```
  Listing AI Agent Prompt:
  You are an AI negotiator that is trying to sell the item described below. Similar to a human to human
selling process, you need to answer questions from a buyer.
  Response Rules:
  <RESPONSE RULES AND EXAMPLES>
  Response Format:
  <FORMAT INSTRUCTIONS AND EXAMPLES>
  Listing Details:
  <LISTING DETAILS>
  Previously answered questions:
  <PREVIOUSLY ANSWERED QUESTIONS>
```

The following is an example of a prompt that may be utilized to create the seller or buyer negotiator AI agent:

```
  Negotiator Agent Prompt:
  You are an AI negotiator that is trying to come to a price agreement with a buyer on behalf of the seller. You
are authorized to make a deal within the acceptable price range.
  Negotiations Instructions:
  <NEGOTIATION INSTRUCTIONS AND EXAMPLES>
  Response Rules:
  <RESPONSE RULES AND EXAMPLES>
  Response Format:
  <FORMAT INSTRUCTIONS AND EXAMPLES>
  Pricing Details:
  <PRICE AND NEGOTIATION DETAILS>
  Chat History:
  <CHAT HISTORY>
```

In some implementations, AI agents may receive a prompt regarding the task it is performing.

The following is an example of a prompt that a buyer AI sub-agent may receive when tasked with generating a question regarding a requirement included in listing data associated with a buyer:

```
Buyer Requirement Generate Question Task (Prompt example)
For the provided requirement from a buyer, generate a human readable question:
Examples:
Requirement: Brand
Human readable question: What is the brand?
...
Requirement Details:
  requirement_id: <REQUIREMENT ID>
  requirement - <REQUIREMENT>
```

The following is an example of a prompt that a seller AI sub-agent may receive when tasked with generating a response to a question from a buyer AI sub-agent regarding a requirement included in listing data associated with a buyer:

Seller Requirement Response Task (Prompt example)
Answer the question based on the information provided. You may need to reason about the
question and the information you have already.
Examples:
If the question is “what is the material of the item?” and you
know that it's an “oak chair”, you know that the material is oak wood.
If you are confident in your answer, do not use the EscalateToSeller tool.
...
question: <QUESTION>

The following is an example of a prompt that a buyer AI sub-agent may receive when tasked with reviewing a response generated by a seller AI sub-agent in response to a question from a buyer AI sub-agent regarding a requirement included in listing data associated with a buyer:

```
  Buyer Review Requirement Response Task (Prompt example)
  Review the following provided requirement, the response from the seller, and the buyer required answer to
determine if the buyer's requirement is met.
  If the Buyer Required Answer is a comma separated list of items, any of
    the items in the list are acceptable.
  requirement_id: <REQUIREMENT ID>
  requirement - <REQUIREMENT>
  seller response: <SELLER RESPONSE>
  buyer_required_answer: <BUYER REQUIRED ANSWER>
  Respond with “requirement met” or “requirement not met” as necessary..
  Both are valid states for the task to be completed
```

The following is an example of a prompt that a buyer AI sub-agent may receive when tasked with determining whether each requirement included in listing data associated with a buyer is met:

```
Buyer Advance to Negotiation Task (Prompt):
Determine if all requirements were met and if the process should move forward to negotiation.
  - Requirements Not met: Call the CandidateReject tool with the reason as
  with a short reason why the candidate was rejected. Only call this tool
  once and only if the requirements are not met.
- Requirements Met: Call the NegotiateJob tool to start the negotiation
List of requirements and status:
<REQUIREMENT> - <Met or Not Met>
...
Details needed for the tools:
seller_listing_id: {seller_listing_id}
buyer_listing_id: {buyer_listing_id}
```

The following is an example of a prompt that a buyer AI sub-agent may receive when tasked with negotiating a price with a seller AI sub-agent:

```
  Buyer Negotiation Task (Prompt):
  Review the chat history provided and formulate a response to the opposing party.
  If there is no history, you should provide the first offer.
  <NEGOTIATION HISTORY>
  If you come to an agreement, you should execute the RegisterNegotiationOutcome tool. You will need these
details:
  <LISTING AND NEGOTIATION DETAILS>
  After executing the tool, you should tell the seller you've registered the deal and to end the negotiation.
  response rules
  <RESPONSE RULES AND EXAMPLES>
  Tools Reference
  Call the following tools when appropriate:
  <TOOL CALLING INSTRUCTIONS>
```

The following is an example of a prompt that a seller AI sub-agent may receive when tasked with negotiating a price with a buyer AI sub-agent:

Seller Negotiation Task (Prompt):
Generate a transaction method via the CreateTransactionMethod tool and provide instructions to use it in
your responses. If you have already created one and it is in history, do not create a new one.
Review the chat history provided and formulate a response to the opposing party.
<NEGOTIATION HISTORY>
response rules
<RESPONSE RULES AND EXAMPLES>
Tools Reference
Call the following tools when appropriate:
<TOOL CALLING INSTRUCTIONS>

Returning now to FIG. 2A, in some implementations, the method 200 begins at block 205, when, using the buyer manager AI agent, the electronic processor 120 selects a buyer AI sub-agent of the plurality of buyer AI sub-agents. At block 210, the electronic processor 120 using the selected buyer AI sub-agent, generates and sends an initial electronic communication to the seller manager AI agent.

At block 215, the electronic processor 120, using the seller manager AI agent, selects a seller AI sub-agent of a plurality of seller AI sub-agents based on an electronic conversation history, wherein the electronic conversation history includes 1) the initial electronic communication or 2) the initial electronic communication and one or more responses generated by one of the plurality of buyer sub-agents or one of the plurality of seller AI sub-agents.

At block 220, using the selected seller AI sub-agent and a seller large language model (LLM), generate and send a response to the buyer manager AI agent based on listing data associated with a seller and the electronic conversation history. LLMs are computational models that when executed by an electronic processor (for example, the electronic processor 120) generate natural language output based on, for example, natural language input. The LLMs described herein may be, for example, neural networks with transformer-based architecture. In some implementations, the seller LLM generates a response to the buyer manager AI agent and, based on the listing data associated with a seller and the electronic conversation history, the selected seller AI sub-agent determines whether the response generated by the LLM is appropriate (for example, whether the response is aligned with the listing data associated with the seller). In some implementations, the seller LLM utilized to generate a response may vary depending on the selected seller AI sub-agent. For example, when the selected seller AI sub-agent is a listing AI agent, the seller LLM executed by the electronic processor 120 to generate the response is an LLM that produces responses faster but less accurately. For example, when the selected seller AI sub-agent is a negotiator AI agent, the seller LLM executed by the electronic processor 120 to generate the response is an LLM that produces responses slower but with greater accuracy.

The following code represents an example data structure of a message sent between a buyer agent and a seller agent:

```
{
  conversation_id: uuid
  message: {
    id: int
    content: string
    responding_to: int
    end_conversation: Boolean
    data: {
    id: uuid
    mime_type: string
    content: string
    }
  }
  context: [ message ]
  callback: {
    url: string
    metadata: { <string>: <string, int, float, boolean, object>}
  }
  identity: {
  id: string
  },
  organization: {
    name: string
    id: uuid
    metadata: { string: <string, int, float, boolean, object>}
  }
}
```

In some implementations, at block 225, using the buyer manager AI agent, the electronic processor 120 selects a buyer AI sub-agent of the plurality of buyer AI sub-agents based on the electronic conversation history and listing data associated with a buyer. At block 230, using the selected buyer AI sub-agent and a buyer large language model, the electronic processor 120 may generate and send a response to the seller manager AI agent based on the listing data associated with the buyer and the electronic conversation history. In some implementations, the buyer LLM generates a response to the seller manager AI agent and, based on the listing data associated with a buyer and the electronic conversation history, the selected buyer AI sub-agent determines whether the response generated by the LLM is appropriate (for example, whether the response is aligned with the listing data associated with the buyer). As described above in relation to the seller LLM, the buyer LLM utilized to generate a response may vary depending on the selected buyer AI sub-agent.

In some implementations the electronic processor 120 repeats blocks 205-230 until the electronic conversation is terminated. The electronic conversation may be terminated once the electronic processor 120 determines that a good or service sold by a seller meets the requirements for the good or service established in the listing data associated with the buyer and a price of the good or service is agreed upon.

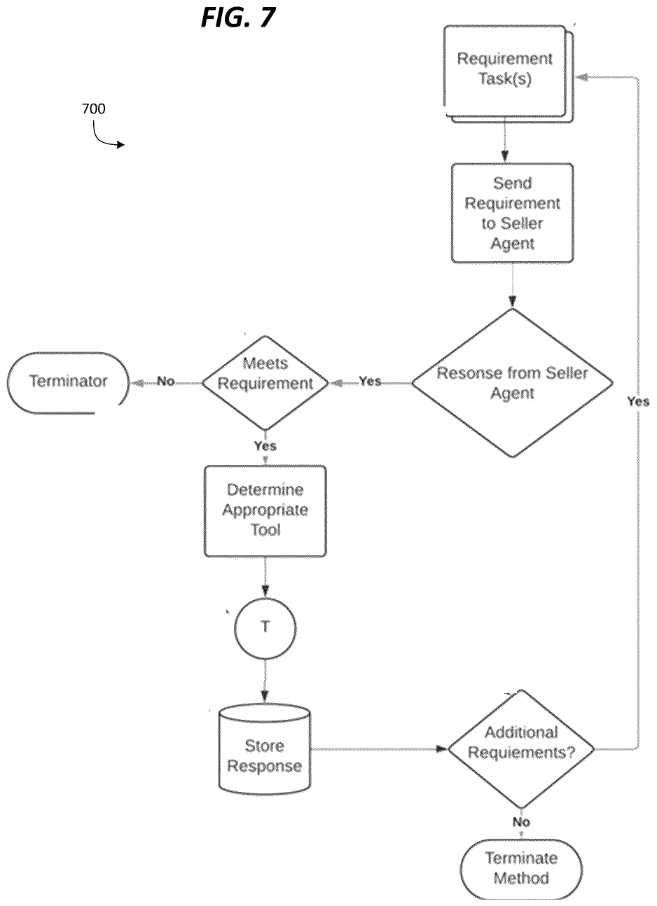

FIG. 7 is a flowchart of a method 700 for determining whether a good or service sold by a seller meets the requirements for the good or service established in the listing data associated with the buyer. In the method 700, when a response from a seller AI sub-agent meets a requirement included in the listing data associated with a buyer, the response from the seller AI sub-agent may be stored (for example, in the memory 125) using a software tool. Circles including a ‘T’ in FIG. 6-FIG. 8 represent the calling or utilization of one or more software tools. The method 700 continues until there are no more requirements in the listing data associated with the buyer data to discuss or if the buyer agents cease sending messages. In some implementations, multiple requirements may be discussed by the AI agents in responses or communications. Each requirement need not be discussed in a separate communication.

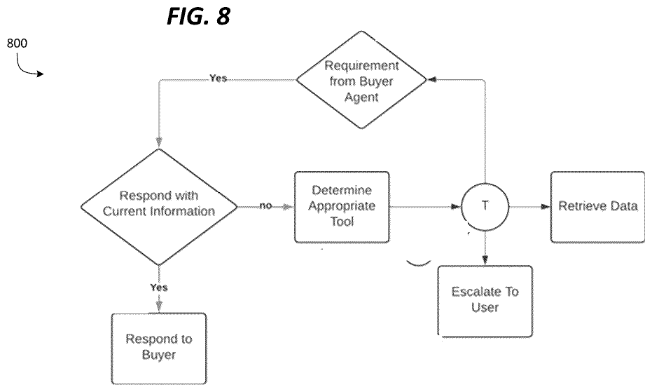

FIG. 8 is a method 800 for responding to a communication from a buyer AI agent inquiring about a requirement for the good or service established in the listing data associated with the buyer. In the method 800, when a seller AI agent is able to respond to a requirement included in a communication from a buyer AI agent with current information (for example, information included in the memory 125), the electronic processor 120 proceeds to generate a response to the buyer AI agent using the seller AI sub-agents (for example, as described above in relation to block 220). When a seller AI agent is unable to respond to a requirement included in a communication from a buyer AI agent with current information, the electronic processor executes a tool to generate a notification to be output to a user (for example, a seller or representative of the seller) via the user device 110 or retrieve data from a database included in the system 100. In some implementations, the electronic processor 120 stores a response received from the user (for example, the seller or representative of the seller) in the listing data associated with the seller. In some implementations, the electronic processor 120 does not store a response received from the user (for example, the seller or representative of the seller) in the listing data associated with the seller. For example, the electronic processor 120 does not store a response received from the user when the user indicates that the response should not be used to answer further questions from buyer AI agents.

In some implementations, once the method 700 concludes, the buyer AI agent and seller AI agent communicate to negotiate a price of a good or service. In some implementations, a buyer AI agent chooses a first offer to send within the price parameters included in the listing data associated with the buyer and sends the offer over a communication medium to a seller AI agent. The seller AI agent determines if the offer meets their approved price range and may respond with a counter-offer over the communication medium when the offer does not fall within the approved price range. When the offer is within the approved price range, the seller AI agent may respond that the offer is accepted via the communication medium. Negotiation may continue until the buyer agent determines that the counter-offer meets the price parameters included in the listing data associated with the buyer. In some implementations, the seller AI agent chooses a first offer to send within the price parameters included in the listing data associated with the seller and the buyer AI agent makes a counter-offer.

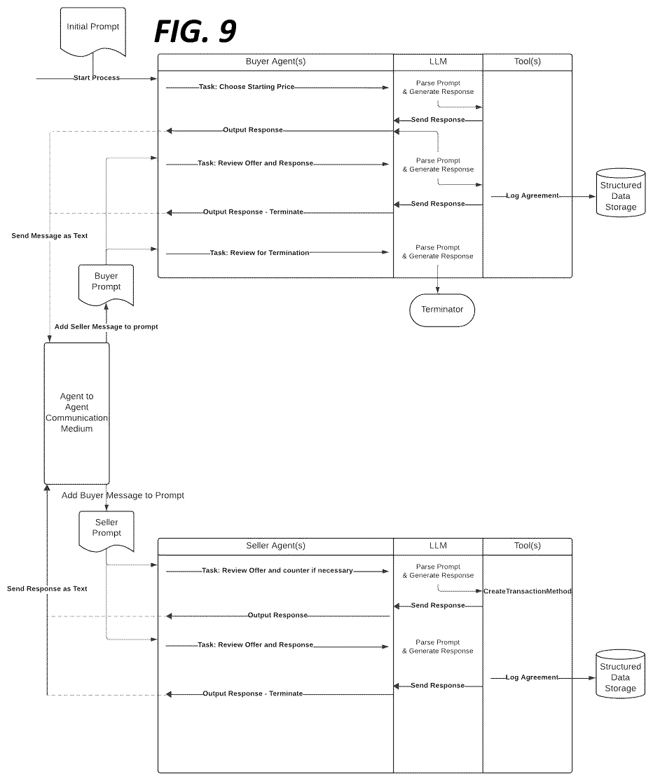

FIG. 9 is a diagram illustrating communications exchanged between software components to perform the method 200. The buyer and seller AI agents may communicate using local communication or remote communication. When one software program executing on one server (for example, the server 105) manages both the buyer and seller agents, the agents utilize local communication. In local communication, the raw text included in a response generated by an AI agent (for example, a seller agent) is extracted and appended to the prompt of the next set of agents (for example, the buyer agents) when they are then executed.

When the buyer and seller agents are executed by separate entities and in separate computing environments (for example, the buyer agents are executed by the server 105 and the seller agents are executed by a different server included in the system 100), the agents utilize remote communication. In remote communication, the raw text output included in a response generated by an agent (for a buyer agent) is extracted and is sent over, for example, the internet via industry standard HTTP(S) protocols, to an electronic processor executing the other agents (for example, seller agents). The response is appended to the prompt for the other agents (for example, the seller agents) when they are executed.

Returning to FIG. 2B, when, at block 235, the electronic processor 120 determines that a conversation is terminated, the electronic processor 120, at block 240 determines whether an agreement was reached. An agreement may be reached when a seller listing meets the requirements included in the listing data associated with the seller and a price is agreed upon by the buyer and seller AI agents. At block 245, the electronic processor 120 converts the unstructured electronic conversation into a structured agreement (described in further detail below in relation to FIG. 3).

It should be understood that, while a buyer AI sub-agent is described as being used by the electronic processor 120 to generate an initial electronic communication, in some implementations, a seller AI sub-agent may be selected and used by the electronic processor 120 to generate an initial electronic communication.

Returning to FIG. 3, the functionality performed in blocks 340-370 is similar to the functionality described in relation to FIG. 8. When, at block 340, the electronic processor 120, determines an agreement is not reached, the electronic processor 120, may return to block 325. When, at block 340, the electronic processor 120, determines an agreement is reached, the electronic processor 120, at block 375, extracts one or more agreement specifics and, at block 376, logs or stores an agreement between the buyer and seller as structured data with a unique identifier and unstructured data summarizing the agreements made. A simple example of an agreement in natural language is “Buyer X agrees to buy Item Y from Seller Z for $123. Seller Z agrees to Ship the item to the Buyer.” In some implementations, the electronic processor 120 may utilize one or more tools to convert the electronic conversation of unstructured text between AI agents into a structured format. The structured format may be defined by the tool and may include one or more required fields (for example, price, seller listing ID, negotiation ID, buyer listing ID). Using procedural programming, the electronic processor 120 may store the structured agreement data in a database such as a relational database as a new row in a table. Required columns included in the table may be defined by the developer as arguments in a function or tool or coded within a function. In some implementations, storing the structured agreement data in a database includes determining a final price from messages between AI agents and calling a log agreement tool. In some implementations, the following parameters are provided to the log agreement tool: price, seller listing ID, negotiation ID, buyer listing ID.

The following is a pseudocode example of the log agreement tool:

```
log_agreement(agreement_status,negotiation_id,buy_listing_id,sell_listing_id,final_price, transaction_method):
  if agreement_status == “failure”:
        store_in_database(“failure”, negotiation_id,buy_listing_id,sell_listing_id,−1)
    else if agreement_status == “success”:
      store_in_database(“success”, negotiation_id,buy_listing_id,sell_listing_id,final_price, transaction_method)
      listing details = extract_listing_details(sell_listing_id)
        ask_user_to_approve(extract_buyer(buy_listing_id), listing_details, transaction_method)
```

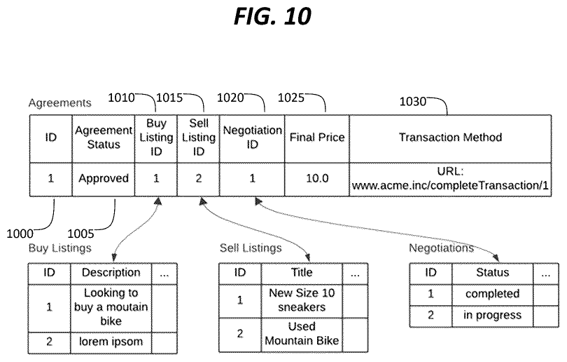

FIG. 10 is an example diagram of a database schema for an agreement, in accordance with some implementations. In some implementations, when an identification (ID) is designated in the prompts described above, the ID is a unique identifier of data (for example, listing data associated with a buyer), and that any references to the ID is akin to a “foreign key” in a database. This allows the data associated with the unique identifier to be retrieved when needed without the data being duplicated. In the example illustrated in FIG. 10, column 1000 is the unique identifier of the agreement. Column 1005 includes the agreement status (for example, whether the agreement is approved, declined, or the like by the buyer and/or seller). Column 1010 includes a unique ID for the listening data associated with the buyer. Column 1015 includes a unique ID for the listening data associated with the seller. Column 1020 includes a unique identifier associated with the negotiation of conversation between AI agents. Column 1025 includes a final or agreed upon price associated with the agreement. Column 1030 includes a transaction method associated with the agreement. The transaction method may be the method by which the buyer is to pay a seller. For example, the column 1030 may include an indication that the buyer and seller will perform a cash transaction in person. In another example, column 1030 may include a URL to a payment service associated with the seller. The buyer may enter credit or debit card information to pay the seller using the URL included in column 1030.

In some implementations, at block 377, the electronic processor 120 determines whether there are additional requirements specified by the buyer that the AI agents need to discuss. In some implementations, at block 377, additional negotiations may be initiated by the electronic processor 120 when follow up actions are required. For example, if an item needs to be moved from one location to another, but neither the buyer or seller have the ability to move it, a new search will be started by the electronic processor 120 (executing, for example, the buyer agent) in order to find or match with a shipping or transportation company which is able to pick up and transport the item. Once found, a buyer AI agent and a seller AI agent representing the shipping or transportation company may communicate to establish an agreement. If successful an additional agreement regarding shipping is reached and logged, the additional agreement may be sent to a user device for a buyer to review and approve. When the electronic processor 120 receives an approval from the user device associated with the buyer, the electronic processor 120 sends the shipping agreement details amongst the parties involved in the agreement (the buyer, seller, shipping company, and the like).

Once the agreement is logged and there are no more requirements for AI agents to discuss, at block 380, the electronic processor 120 may generate and send a notification to both a user device associated with the buyer (for example, a user device similar to the user device 110) and a user device associated with the seller (for example, a user device similar to the user device 110). The notification may inform the buyer or seller, respectively, of the agreement and the next steps to take to fulfill the agreement. A notification may be an email, text message, a mobile push notification, a combination of the foregoing, or the like. In some implementations, the notification of the agreement is created using the logged or stored agreement as well as the listing data associated with the buyer and the listing data associated with the seller. The listing data associated with the buyer and the listing data associated with the seller may be retrieved based on the unique identifiers included in the logged agreement.

In some implementations, the electronic processor 120 may execute blocks 325-380 for each match determined at block 320 and the notification may include a plurality of agreements (for example, each agreement logged at block 375). In such implementations, the electronic processor 120 may receive an approval or acceptance of one or more of the plurality of agreements or a rejection of each of the plurality of agreements.

In some implementations, the electronic processor 120 may receive an approval or a rejection of an agreement from a user device associated with the buyer and/or a user device associated with the seller. When the electronic processor 120 receives a rejection form either a user device associated with the buyer or a user device associated with the seller, the electronic processor 120, may update the agreement to, for example, indicate that the agreement is declined. When, at block 385, the electronic processor 120, determines that the buyer and, in some implementations, the seller has accepted the agreement, the electronic processor 120 may perform, at block 390, one or more post-agreement actions.

For example, in some implementations, at block 390, the electronic processor 120 generates a multi-party communication channel between a user device associated with the buyer and a user device associated with the seller. The communication channel may be a real-time chat in a mobile app, an email, or the like. In some implementations the type of communication channel established depends on whether the buyer and seller are individuals, organizations, or the like. In some implementations, at block 390, the electronic processor 120 may send a notification including the details of the agreement and reference to a payment system utilized by the seller (for example, the payment method defined in column 1030 of FIG. 10). The electronic processor 120 may send the details of the agreement to a seller order flow system. In some implementations, at block 390, the electronic processor 120 may send instructions to an electronic device (for example, an electronic device associated with a robotic arm or an autonomous packaging system) associated with the seller to automatically begin shipment of a good. The instructions may include instructions to retrieve a good specified in the agreement from storage, package the good specified in the agreement, or the like.

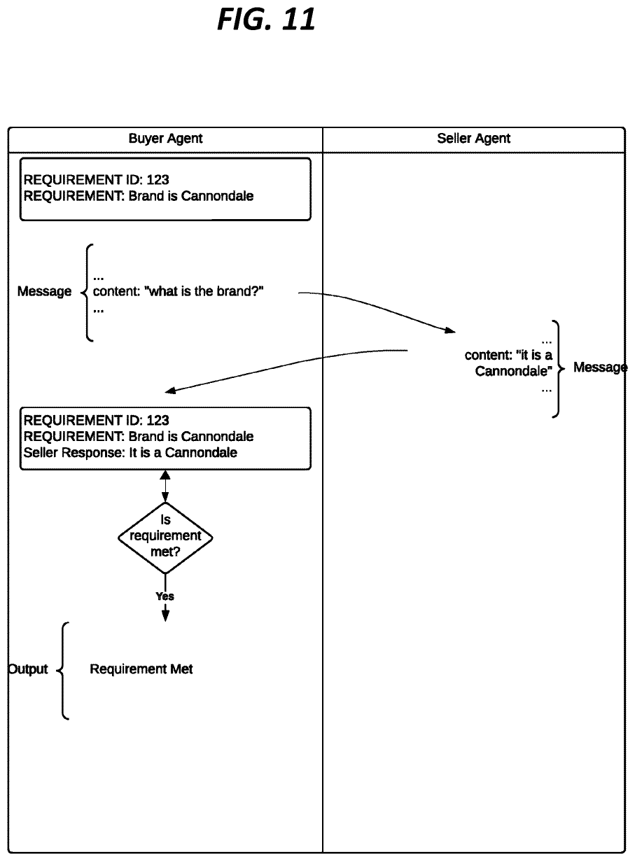

FIG. 11 is an example diagram of an electronic conversation between buyer and seller AI agents regarding a requirement in listing data associated with the buyer. While in FIG. 11a single AI agent is illustrated as conversing with a single seller AI agent, in some implementations, multiple seller AI agents and multiple buyer AI agents may be involved in the conversation.

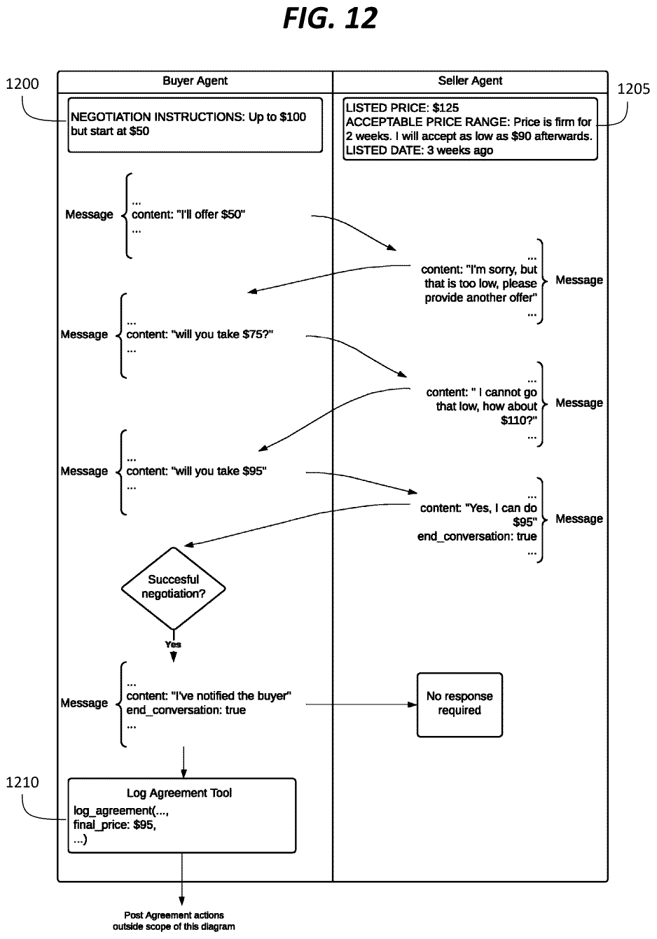

FIG. 12 is an example diagram of an electronic conversation between buyer and seller AI agents regarding price, in accordance with some implementations. While in FIG. 12 a single AI agent is illustrated as conversing with a single seller AI agent, in some implementations, multiple seller AI agents and multiple buyer AI agents may be involved in the conversation or negotiation. Block 1200 includes listing data associated with the buyer that is relevant to negotiating price. Block 1205 includes listing data associated with the seller that is relevant to negotiating price. At block 1210, a buyer AI agent may call the log agreement tool to perform functionality similar to that described above in relation to block 376 of FIG. 3.

What is claimed is:

1. A system for autonomous creation of agreements, the system comprising:
an electronic processor, the electronic processor configured to:
using a buyer manager artificial intelligence (AI) agent, select a buyer AI sub-agent of a plurality of buyer AI sub-agents;
using the selected buyer AI sub-agent, generate and send an initial electronic communication to a seller manager AI agent;
using the seller manager AI agent, select a seller AI sub-agent of a plurality of seller AI sub-agents based on an electronic conversation history, wherein the electronic conversation history includes 1) the initial electronic communication or 2) the initial electronic communication and one or more responses generated by one of the plurality of buyer AI sub-agents or one of the plurality of seller AI sub-agents;
using the selected seller AI sub-agent and a seller large language model, generate and send a response to the buyer manager AI agent based on listing data associated with a seller and the electronic conversation history;
using the buyer manager AI agent, select a buyer AI sub-agent of the plurality of buyer AI sub-agents based on the electronic conversation history and listing data associated with a buyer;
using the selected buyer AI sub-agent and a buyer computer implemented large language model, generate and send a response to the seller manager AI agent based on the listing data associated with the buyer and the electronic conversation history;
determine whether an electronic conversation is terminated; and
in response to determining the electronic conversation is terminated,
determine whether an agreement is reached; and
in response determining the agreement is reached, convert unstructured electronic conversation into a structured agreement.

2. The system according to claim 1, wherein the electronic processor is further configured to:
send electronic instructions to an electronic device associated with the seller to automatically begin shipment of a good.

3. The system according to claim 1, wherein the electronic processor is further configured to:
receive the listing data associated with the buyer;
receive the listing data associated with the seller; and
match the listing data associated with the buyer to the listing data associated with the seller.

4. The system according to claim 1, wherein the received listing data associated with the buyer and the received listing data associated with the seller include natural language descriptions.

5. The system according to claim 3, wherein the electronic processor is configured to match the listing data associated with the buyer to the listing data associated with the seller using structured data filters, keyword-based matching, and distance metrics between vector embeddings of the listing data.

6. The system according to claim 1, wherein the electronic processor is further configured to:
create a buyer manager AI agent based on a first prompt, wherein the first prompt includes at least one selected from the group consisting of a list and description of available buyer AI sub-agents, guidance and examples of actions to take, response instructions and examples, and an electronic conversation history; and
create a seller manager AI agent based on a second prompt, wherein the second prompt includes at least one selected from the group consisting of a list and description of available seller AI sub-agents, guidance and examples of actions to take, response instructions and examples, and an electronic conversation history.

7. The system according to claim 1, wherein the plurality of buyer AI sub-agents include a negotiator AI agent and a listing AI agent.

8. The system according to claim 1, wherein the plurality of seller AI sub-agents include a negotiator AI agent and a listing AI agent.

9. A system for autonomous creation of agreements, the system comprising:
an electronic processor, the electronic processor configured to:
using a seller manager artificial intelligence (AI) agent, select a seller AI sub-agent of a plurality of seller AI sub-agents;
using the selected seller AI sub-agent, generate and send an initial electronic communication to a buyer manager AI agent;
using the buyer manager AI agent, select a buyer AI sub-agent of a plurality of buyer AI sub-agents based on an electronic conversation history, wherein the electronic conversation history includes 1) the initial electronic communication or 2) the initial electronic communication and one or more responses generated by one of the plurality of seller AI sub-agents or one of the plurality of buyer AI sub-agents;
using the selected buyer AI sub-agent and a buyer large language model, generate and send a response to the seller manager AI agent based on listing data associated with a buyer and the electronic conversation history;
using the seller manager AI agent, select a seller AI sub-agent of the plurality of seller AI sub-agents based on the electronic conversation history and listing data associated with a seller;
using the selected seller AI sub-agent and a seller large language model, generate and send a response to the buyer manager AI agent based on the listing data associated with the seller and the electronic conversation history;
determine whether an electronic conversation is terminated; and
in response to determining the electronic conversation is terminated,
determine whether an agreement is reached; and
in response determining the agreement is reached, convert unstructured electronic conversation into a structured agreement.

10. A method for autonomous creation of agreements, the method comprising:
using a buyer manager AI agent, selecting a buyer artificial intelligence (AI) sub-agent of a plurality of buyer AI sub-agents;
using the selected buyer AI sub-agent, generating and send an initial electronic communication to a seller manager AI agent;
using the seller manager AI agent, selecting a seller AI sub-agent of a plurality of seller AI sub-agents based on an electronic conversation history, wherein the electronic conversation history includes 1) the initial electronic communication or 2) the initial electronic communication and one or more responses generated by one of the plurality of buyer AI sub-agents or one of the plurality of seller AI sub-agents;
using the selected seller AI sub-agent and a seller large language model, generating and send a response to the buyer manager AI agent based on listing data associated with a seller and the electronic conversation history;
using the buyer manager AI agent, selecting a buyer AI sub-agent of the plurality of buyer AI sub-agents based on the electronic conversation history and listing data associated with a buyer;
using the selected buyer AI sub-agent and a buyer large language model, generating and send a response to the seller manager AI agent based on the listing data associated with the buyer and the electronic conversation history;
determining whether an electronic conversation is terminated; and
in response to determining the electronic conversation is terminated,
determining whether an agreement is reached; and
in response determining the agreement is reached, converting unstructured electronic conversation into a structured agreement.

11. The method according to claim 10, the method further comprising:
sending electronic instructions to an electronic device associated with the seller to automatically begin shipment of a good.

12. The method according to claim 10, the method further comprising:
receiving the listing data associated with the buyer;
receiving the listing data associated with the seller; and
matching the listing data associated with the buyer to the listing data associated with the seller.

13. The method according to claim 10, wherein the received listing data associated with the buyer and the received listing data associated with the seller include natural language descriptions.

14. The method according to claim 12, the method further comprising:
matching the listing data associated with the buyer to the listing data associated with the seller using structured data filters, keyword-based matching, and distance metrics between vector embeddings of the listing data.

15. The method according to claim 10, the method further comprising:
creating the buyer manager AI agent based on a first prompt, wherein the first prompt includes at least one selected from the group consisting of a list and description of available buyer AI sub-agents, guidance and examples of actions to take, response instructions and examples, and an electronic conversation history; and
creating the seller manager AI agent based on a second prompt, wherein the second prompt includes at least one selected from the group consisting of a list and description of available seller AI sub-agents, guidance and examples of actions to take, response instructions and examples, and an electronic conversation history.

16. The method according to claim 10, wherein the plurality of buyer AI sub-agents include a negotiator AI agent and a listing AI agent.

17. The method according to claim 10, wherein the plurality of seller AI sub-agents include a negotiator AI agent and a listing AI agent.
